(19) United States
(12) Patent Application Publication
(10) Pub. No.: US 2017/0280410 A1
(43) Pub. Date: Sep. 28, 2017

(54) METHOD, DEVICE AND SYSTEM FOR IMPLEMENTING INFORMATION SELF-REGISTRATION, AND COMPUTER STORAGE MEDIUM

(71) Applicant: ZTE Corporation, Shenzhen, Guangdong (CN)

(72) Inventor: Hong LUO, Shenzhen (CN)

(21) Appl. No.: 15/504,735

(22) PCT Filed: Apr. 13, 2015
(86) PCT No.: PCT/CN2015/076467

§ 371 Date: Feb. 17, 2017

(30) Foreign Application Priority Data
Aug. 20, 2014 (CN) 201410413663.6

(51) Int. Cl. H04W 60/04

(52) U.S. Cl. CPC H04W 60/04

(57) ABSTRACT

A method, terminal, server and system for implementing information self-registration, and a computer storage medium. When a terminal starts for the first time or registration information of the terminal changes, the terminal sends to a server a self-registration session operation packet carrying current registration information of the terminal (S10); the server receives and parses the self-registration session operation packet to acquire the current registration information of the terminal (S20); determine whether the current registration information is new registration information according to pre-stored registration information of the terminal (S21); and if the current registration information is new registration information, save the new registration information and send a response message of successful self-registration session operation to the terminal (S22).

### TECHNICAL FIELD

The present disclosure generally relates to Device Management (DM) techniques in the mobile communication field, and more particularly to a method, terminal, server, system and computer storage medium for implementing information self-registration.

### BACKGROUND

With the rapid development of the electronic techniques, more and more terminal devices have an Open Mobile Alliance DM (OMA DM) function. Therefore, terminal management, such as terminal information collection and configuration, fault detection and reparation, and software version updating, may be achieved only by means of interaction between a server and a terminal device. Furthermore, the server provides a terminal management service based on registration information of paired terminals. The registration information may include the following items corresponding to one another: a device unique identifier (DevId), a terminal model (Mod), a terminal manufacturer (Man), a phone number and the like.

In the related art, when the server lacks registration information of the terminal, the terminal management may be achieved in such a way that the terminal initiates connection to the server. However, in this way, the server may fail to manage the terminal at anytime and anywhere, and the server cannot be flexibly switched via a booting program (Bootstrap). Furthermore, when a new card is inserted into the terminal (or a new number is written into the terminal) or when a terminal parameter is maliciously corrupted during a terminal management session, the server may be unable to perform terminal management. Therefore, how the server acquires current registration information of the terminal, is always the most important issue for the terminal management via the interaction between the server and the terminal.

### SUMMARY

An embodiment of the present disclosure provides a method, terminal, server, system and computer storage medium for implementing information self-registration, which may guarantee that the server can obtain current registration information of the terminal in real time, enabling the server to effectively manage the terminal.

The technical solutions according to an embodiment of the disclosure may be implemented as follows.

An embodiment of the disclosure provides a method for implementing information self-registration, including:

transmitting a self-registration session operation packet which carries current registration information of a terminal, when the terminal starts for a first time or registration information of the terminal is changed;

receiving a response message indicating success of a self-registration session operation; and

ending the self-registration session operation process.

According to an embodiment, the method may further include: repeatedly transmitting, by the terminal, the self-registration session operation packet until the response message indicating the success of the self-registration session operation is received, when the self-registration session operation fails.

According to an embodiment, the carrying the current registration information of the terminal in the self-registration session operation packet may include: adding a node related to the current registration information of the terminal, into an extendable node of the self-registration session operation packet, and identifying the self-registration session operation packet with a message type in a predefined field.

According to an embodiment, the node related to the current registration information of the terminal may include a telephone number currently used by the terminal or a version number of the terminal.

An embodiment of the disclosure further provides a method for implementing information self-registration, including:

receiving and parsing a self-registration session operation packet to obtain current registration information of a terminal;

judging whether the current registration information is new registration information based on pre-stored registration information of the terminal;

saving the new registration information and transmitting a response message indicating success of a self-registration session operation, when the current registration information is new registration information.

An embodiment of the disclosure further provides a terminal, including a first transmission module and a first reception module, where:

the first transmission module is arranged to transmit a self-registration session operation packet which carries current registration information of the terminal, when the terminal starts for a first time or registration information of the terminal is changed; and

the first reception module is arranged to receive a response message indicating success of a self-registration session operation, and end the self-registration session operation process.

According to an embodiment, the first transmission module may be further arranged to repeatedly transmit the self-registration session operation packet until the response message indicating the success of the self-registration session operation is received, when the self-registration session operation fails.

An embodiment of the disclosure further provides a server, including a second reception module, a judgment processing module, and a second transmission module, where:

the second reception module is arranged to receive and parse a self-registration session operation packet to obtain current registration information of a terminal;

the judgement processing module is arranged to judge whether the current registration information is new registration information based on pre-stored registration information of the terminal; and save the new registration information when the current registration information is new registration information; and

the second transmission module is arranged to transmit a response message indicating success of a self-registration session operation.

An embodiment of the disclosure further provides a system for implementing information self-registration, including a terminal and a server, where:

the terminal is configured to transmit, to the server, a self-registration session operation packet which carries current registration information of the terminal, when the terminal starts for a first time or registration information of the terminal is changed; and receive a response message indicating success of a self-registration session operation and end the self-registration session operation process; and

the server is configured to receive and parse the self-registration session operation packet to obtain current registration information of the terminal; judge whether the current registration information is new registration information based on pre-stored registration information of the terminal; and save the new registration information and transmit, to the terminal, the response message indicating the success of the self-registration session operation, when the current registration information is new registration information.

An embodiment of the disclosure further provides a computer storage medium storing a computer executable instruction for executing the method for implementing information self-registration applied in the terminal.

An embodiment of the disclosure further provides a computer storage medium storing a computer executable instruction for executing the method for implementing information self-registration applied in the server.

According to the method, terminal, server and system provided by embodiments of the disclosure, when a terminal starts for a first time or when registration information of the terminal is changed, the terminal transmits, to a server, a self-registration session operation packet which carries current registration information of the terminal. The server then receives and parses the self-registration session operation packet to obtain the current registration information of the terminal, and judges whether the current registration information is new registration information based on pre-stored registration information of the terminal. When the current registration information is new registration information, the server saves the new registration information and transmits, to the terminal, a response message indicating success of a self-registration session operation. In this way, it can be guaranteed that the server can in real time obtain current registration information of the terminal, enabling the server to effectively manage the terminal.

### BRIEF DESCRIPTION OF THE DRAWINGS

FIG. 1 is a first schematic flowchart of a method for implementing information self-registration according to an embodiment of the disclosure;

FIG. 2 is a second schematic flowchart of a method for implementing information self-registration according to an embodiment of the disclosure;

FIG. 3 is a specific flowchart of a method for implementing information self-registration according to an embodiment of the disclosure;

FIG. 4 is a schematic structure diagram of a standard “Devinfo” field node of the OMA DM protocol;

FIG. 5 is a schematic structure diagram of an extended “Devinfo” field node of the

OMA DM protocol;

FIG. 6 is a schematic constituent structure diagram of a terminal according to an embodiment of the disclosure;

FIG. 7 is a schematic constituent structure diagram of a server according to an embodiment of the disclosure; and

FIG. 8 is a schematic constituent structure diagram of a system for implementing information self-registration according to an embodiment of the disclosure.

### DETAILED DESCRIPTION

The present disclosure will be in detail described in conjunction with the appended drawings and embodiments below.

According to an embodiment of the disclosure, when a terminal starts for a first time or when registration information of the terminal is changed, the terminal transmits, to a server, a self-registration session operation packet which carries current registration information of a terminal. The server then: receives and parses the self-registration session operation packet to obtain the current registration information of the terminal, and judges whether the current registration information is new registration information based on pre-stored registration information of the terminal. When the current registration information is new registration information, the server saves the new registration information and transmits, to the terminal, a response message indicating success of a self-registration session operation.

Here, in order to guarantee that the terminal achieves an information self-registration process well, a dedicated message type in a “Generic Alert” field is to be preset to assist the server in judging whether a received session operation packet is a self-registration session operation packet. Meanwhile, a “Devinfo” field node is extended based on a standard node of the OMA DM protocol, that is, a node related to current registration information of the terminal, such as a phone number currently used by the terminal, a version number of the terminal and the like, is added into an extendable “Devinfo” field node.

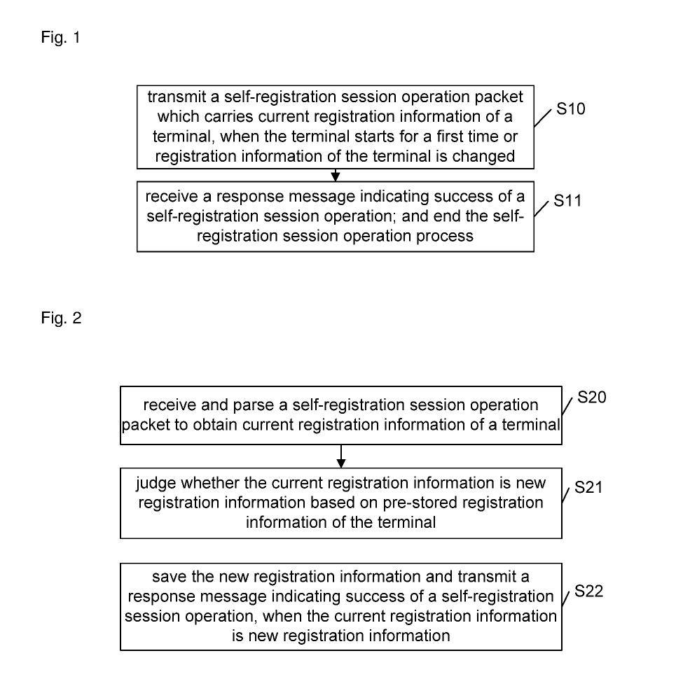

FIG. 1 is a first schematic flowchart of a method for implementing information self-registration according to an embodiment of the disclosure applied at a terminal side. As shown in FIG. 1, the method for implementing information self-registration according to an embodiment of the disclosure includes:

In Step S10, when the terminal starts for a first time or registration information of the terminal is changed, a self-registration session operation packet which carries current registration information of the terminal is transmitted.

Here, a case in which the registration information of the terminal is changed may include a new card being inserted into a terminal, an old card being inserted into a new terminal, a terminal restoring factory settings and the like.

Here, when the terminal waits for a predefined time interval and does not receive a response message indicating success of a self-registration session operation, that is, when the self-registration session operation fails, a self-registration session operation packet is repeatedly transmitted until the response message indicating the success of the self-registration session operation is received. It should be noted that, a case in which the self-registration session operation fails, may include the following possible cases: 1) a network is interrupted and the terminal fails to transmit the self-registration session operation packet to the server; 2) the server is in an abnormal operation state and cannot in time receive the self-registration session operation packet transmitted by the terminal.

Here, the carrying the current registration information of the terminal in the self-registration session operation packet may include: adding a node related to the current registration information of the terminal, into an extendable node, i.e., a “Devinfo” node of the self-registration session operation packet, and identifying the self-registration session operation packet with a message type in a predefined “Generic Alert” field. The current registration of the terminal may include a phone number currently used by the terminal or a version number of the terminal.

In Step S11, the response message indicating the success of the self-registration session operation is received, and the self-registration session operation process is ended.

An embodiment of the disclosure further provides a computer storage medium storing a computer executable instruction for performing the method for implementing information self-registration applied in the terminal.

FIG. 2 is a second schematic flowchart of a method for implementing information self-registration according to an embodiment of the disclosure applied at a server side. As shown in FIG. 2, the method for implementing information self-registration according to an embodiment of the disclosure includes:

In Step 20, a self-registration session operation packet is received and parsed to obtain current registration information of a terminal.

Particularly, after the server receives the self-registration session operation packet which carries current registration information of the terminal, the server may determine the received packet is a self-registration session operation packet based on a message type in a predefined “Generic Alert” field of the self-registration session operation packet. Furthermore, the sever may parse the current registration information based on an extended “Devinfo” field node in the self-registration session operation packet.

In Step 21, whether the current registration information is new registration information, is judged based on pre-stored registration information of the terminal.

Particularly, the server judges whether the current registration information of the terminal is inconsistent with the pre-stored registration information of the terminal, based on a paired relationship of the pre-stored registration information of the terminal, so as to judge whether the current information of the terminal is new registration information. When the current registration information of the terminal is inconsistent with the pre-stored registration information of the terminal in the server, it is judged that the current registration information of the terminal is new registration information.

In Step S22, the new registration information is saved and a response message indicating success of a self-registration session operation is transmitted, when the current registration information is new registration information.

Here, when the current registration information is not new information, that is, when the current information of the terminal has been stored in the server, the server may ignore the self-registration session operation packet currently received, and end the session process.

An embodiment of the disclosure further provides a computer storage medium storing a computer executable instruction for performing the method for implementing information self-registration applied in the server.

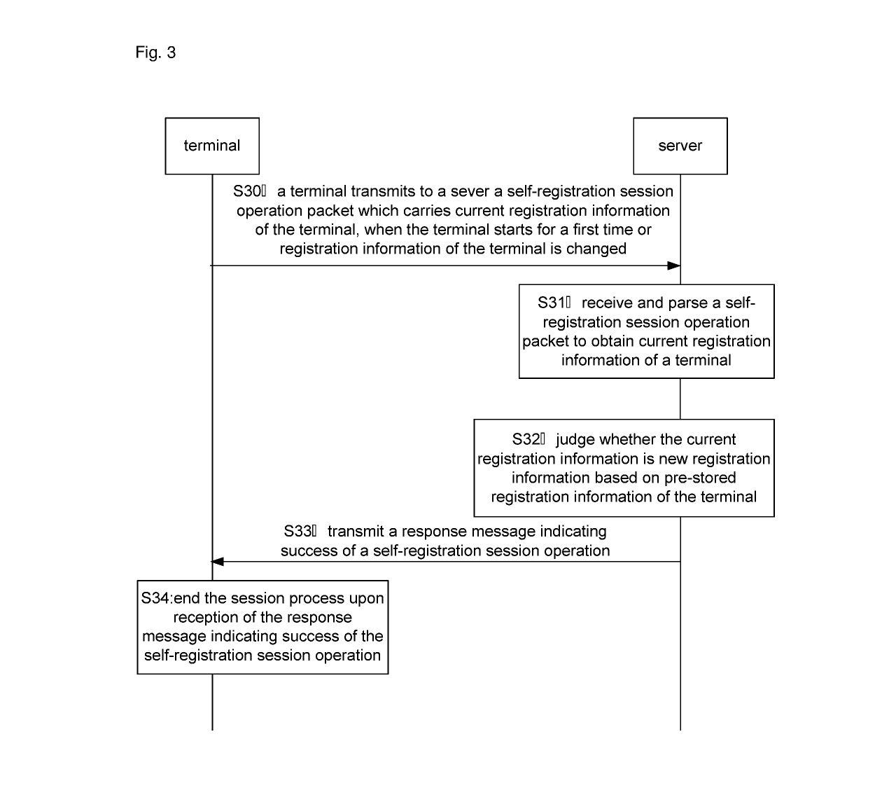

FIG. 3 is a specific flowchart of a method for implementing information self-registration according to an embodiment of the disclosure. As shown in FIG. 3, a method for implementing information self-registration according to an embodiment of the disclosure includes:

In Step S30, a terminal transmits, to a sever, a self-registration session operation packet which carries current registration information of the terminal, when the terminal starts for a first time or registration information of the terminal is changed.

Here, in order to guarantee that the terminal achieves an information self-registration process well, before the Step S30 is performed, a dedicated message type in a “Generic Alert” field is to be preset to assist the server in judging whether a received session operation packet is a self-registration session operation packet. For example, the message type in the “Generic Alert” field may be predefined as follows:

org. open mobile alliance .dm. device information .registration

Meanwhile, a “Devinfo” field node is extended based on a standard node of the OMA DM protocol, that is, a node related to current registration information of the terminal, such as a phone number currently used by the terminal, a version number of the terminal and the like, is added into the “Devinfo” field node.

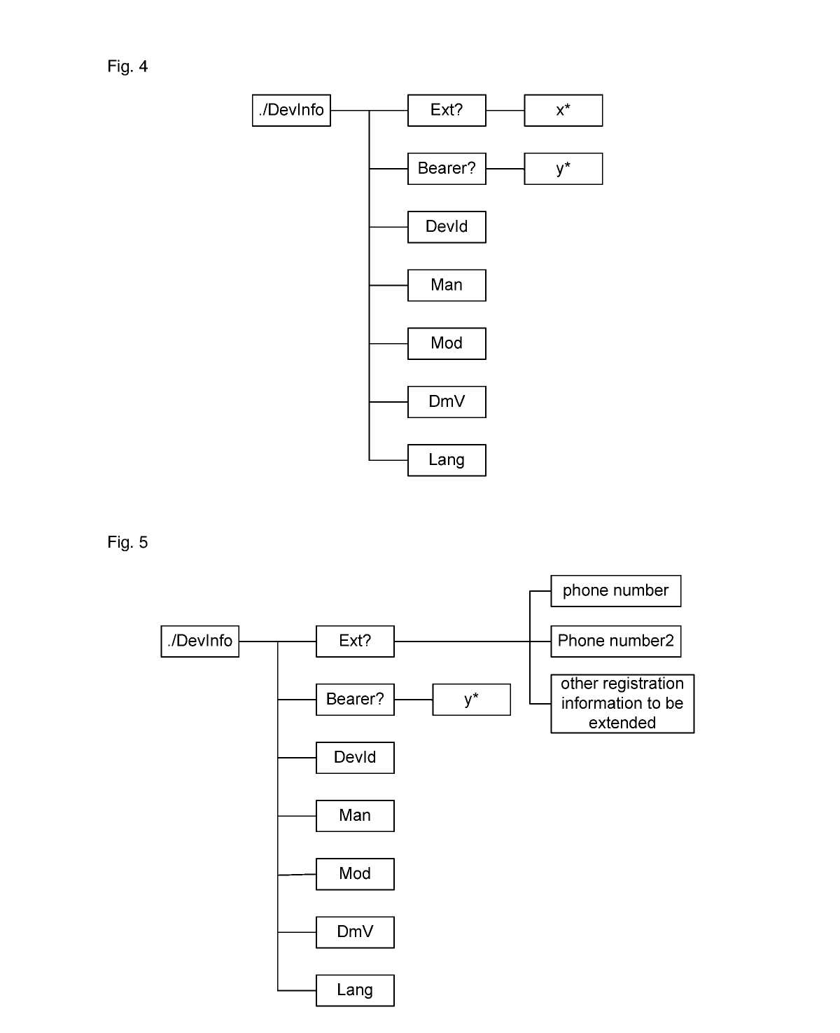

For example, FIG. 4 is a schematic structure diagram of a standard “Devinfo” field node of the OMA DM protocol. A “DevId” field node is a device unique identifier, a “Mod” field node is a terminal model, a “Man” field node is a terminal manufacturer and the like. The “Devinfo” field node is further extended based on a standard node of the OMA DM protocol. Particularly, a phone number (Phone number) node currently used by the terminal or other registration information (Other info) node to be extended is added into the “Devinfo” field node, as shown in FIG. 5. It is to be noted that, when the terminal is a multimode device, the phone number node currently used by the terminal may have multiple phone numbers, such as Phone number 1, Phone number 2 and the like.

In Step S31, the server receives and parses the self-registration session operation packet to obtain current registration information of the terminal.

Particularly, after the server receives the self-registration session operation packet which carries current registration information of the terminal, the server determines the received packet is a self-registration session operation packet based on the message type in the “Generic Alert” field of the self-registration session operation packet. Furthermore, the server parses the self-registration session operation packet to obtain current registration information of the terminal, based on an extended node in the “Devinfo” field node of the self-registration session operation packet.

In Step S32, whether the current registration information is new registration information, is judged based on pre-stored registration information of the terminal; and the new registration information is saved when the current registration information is new registration information.

Particularly, the server judges whether the current registration information of the terminal is inconsistent with the pre-stored registration information of the terminal, based on a paired relationship of the pre-stored registration information of the terminal, so as to judge whether the current information of the terminal is new registration information. When the current registration information of the terminal is inconsistent with the pre-stored registration information of the terminal in the server, for example, in a case of a new terminal plus a new number, a new terminal plus an old number, an old terminal plus a new number and the like, it is judged that the current registration information of the terminal is new registration information.

Here, when the current registration information is not new information, that is, when the current information of the terminal has been stored in the server, the server may ignore the self-registration session operation packet currently received, and end the session process.

In Step S33, the server transmits, to a terminal, a response message indicating success of a self-registration session operation.

Here, when the current registration information is not new information, that is, when the current information of the terminal has been stored in the server, the server may ignore the self-registration session operation packet currently received, and end the session process.

In Step S34, the terminal ends the self-registration session operation process after the terminal receives the response message indicating success of the self-registration session operation.

In this way, according to the method of an embodiment of the disclosure, it can be guaranteed that the server can obtain current registration information of the terminal in real time, enabling the server to effectively manage the terminal.

It is to be noted that, according to an embodiment of the disclosure, before the server transmits, to a terminal, a response message indicating success of a self-registration session operation, when the server detects that registration information of a network-connected terminal is changed or is not provided, the server may, as required, collect a designated registration information of the terminal in such a way that the server transmits a management operation packet to the terminal via a current self-registration session. Furthermore, the terminal completes a designated management operation according to the OMA DM protocol.

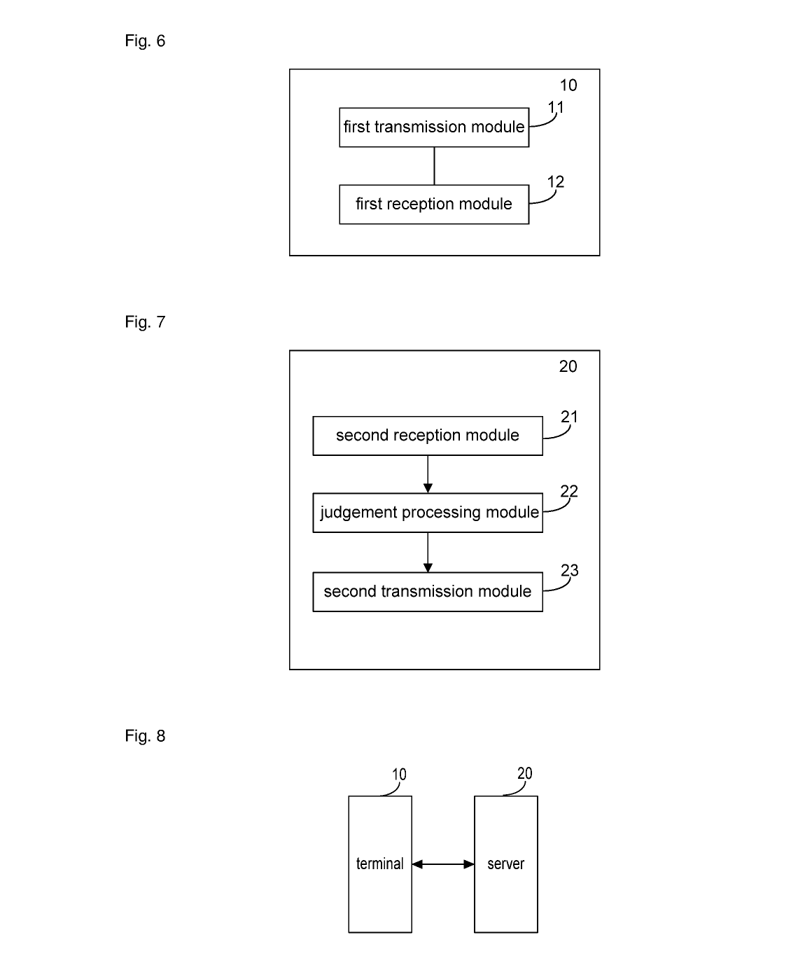

FIG. 6 is a block diagram of a terminal 10 according to an embodiment of the disclosure. As shown in FIG. 6, the terminal includes a first transmission module 11 and a first reception module 12.

The first transmission module 11 is arranged to transmit a self-registration session operation packet which carries current registration information of a terminal, when the terminal starts for a first time or registration information of the terminal is changed; and

The first reception module 12 is arranged to receive a response message indicating success of a self-registration session operation, and end the self-registration session operation process.

Here, the transmission module 11 is further arranged to repeatedly transmit the self-registration session operation packet until the response message indicating the success of the self-registration session operation is received, when the transmission module 11 waits for a predefined time interval and does not receive a response message indicating success of a self-registration session operation, that is, when the self-registration session operation fails.

Here, the carrying the current registration information of the terminal in the self-registration session operation packet may include: adding a node related to the current registration information of the terminal, into an extendable “Devinfo” field node of the self-registration session operation packet, and identifying the self-registration session operation packet with a message type in a predefined “Generic Alert” field.

FIG. 7 is a schematic constituent structure diagram of a server 20 according to an embodiment of the disclosure. As shown in FIG. 7, the server includes a second reception module 21, a judgment processing module 22, and a second transmission module 23.

The second reception module 21 is arranged to receive and parse a self-registration session operation packet to obtain current registration information of a terminal.

The judgement processing module 22 is arranged to judge whether the current registration information is new registration information based on pre-stored registration information of the terminal; and save the new registration information when the current registration information is new registration information.

The second transmission module 23 is arranged to transmit a response message indicating success of a self-registration session operation.

FIG. 8 is a schematic constituent structure diagram of a system for implementing information self-registration according to an embodiment. As shown in FIG. 8, the system includes a terminal 10 and a server 20.

The terminal 10 is configured to transmit, to the server 20, a self-registration session operation packet which carries current registration information of the terminal, when the terminal starts for a first time or registration information of the terminal is changed; and receive a response message indicating success of a self-registration session operation and end the self-registration session operation process.

The server 20 is configured to receive and parse a self-registration session operation packet to obtain current registration information of a terminal; judge whether the current registration information is new registration information based on pre-stored registration information of the terminal; and save the new registration information and transmit, to the terminal 10, the response message indicating the success of the self-registration session operation, when the current registration information is new registration information.

The structure of the terminal may be as shown in FIG. 6, and the structure of the server may be as shown in FIG. 7.

In practice, the transmission module 11 and the reception module 12 may be implemented by a central processing unit (CPU), a micro processing unit (MPU), a digital signal processor (DSP), a field programmable gate array (FPGA) or the like. Either of the transmission module 21, the judgement processing module 22 and the transmission module 23 may be implemented by a CPU, a MPU, a DSP, a FPGA or the like.

The technical solutions cited in the embodiments of the disclosure may be arbitrarily combined without conflictions.

Those skilled in the art shall understand that the embodiments of the disclosure may be provided as a method, a system or a computer program product. Thus, forms of hardware embodiments, software embodiments or embodiments integrating software and hardware may be adopted in the disclosure. Moreover, a form of the computer program product implemented on one or more computer available storage media (including but not limited to, a magnetic disk memory and an optical memory and the like) containing computer available program codes may be adopted in the disclosure.

The disclosure is described with reference to flow charts and/or block diagrams of the method, the device (system) and the computer program product according to the embodiments of the disclosure. It will be appreciated that each flow and/or block in the flow charts and/or the block diagrams and a combination of the flows and/or the blocks in the flow charts and/or the block diagrams may be implemented by computer program instructions. These computer program instructions may be provided for a general computer, a dedicated computer, an embedded processor or processors of other programmable data processing devices to generate a machine, such that an apparatus for implementing functions designated in one or more flows of the flow charts and/or one or more blocks of the block diagrams is generated via instructions executed by the computers or the processors of the other programmable data processing devices.

These computer program instructions may also be stored in a computer readable memory capable of guiding the computers or the other programmable data processing devices to work in a specific mode, such that a manufactured product including an instruction apparatus is generated via the instructions stored in the computer readable memory, and the instruction apparatus implements the functions designated in one or more flows of the flow charts and/or one or more blocks of the block diagrams.

These computer program instructions may also be loaded to the computers or the other programmable data processing devices, such that processing implemented by the computers is generated by executing a series of operation steps on the computers or the other programmable devices, and therefore the instructions executed on the computers or the other programmable devices provide a step of implementing the functions designated in one or more flows of the flow charts and/or one or more blocks of the block diagrams.

The above described are only examples of the embodiments of the disclosure. It should be noted that, the skilled in the art may make various improvements and modifications without departing from the principle of the embodiments of the disclosure, which may fall within the protection scope of the disclosure.

### INDUSTRIAL APPLICABILITY

According to an embodiment of the disclosure, when a terminal starts for a first time or registration information of the terminal is changed, the terminal transmits a self-registration session operation packet which carries current registration information of the terminal to a server. The server then receives and parses the self-registration session operation packet to obtain the current registration information of the terminal, and judges whether the current registration information is new registration information based on pre-stored registration information of the terminal. When the current registration information is new registration information, the server saves the new registration information and transmits, to the terminal, a response message indicating success of a self-registration session operation. In this way, it can be guaranteed that the server can obtain current registration information of the terminal in real time, enabling the server to effectively manage the terminal.

1. A method for implementing information self-registration, comprising:
transmitting a self-registration session operation packet which carries current registration information of a terminal, when the terminal starts for a first time or registration information of the terminal is changed;
receiving a response message indicating success of a self-registration session operation; and
ending the self-registration session operation process.

2. The method according to claim 1, further comprising:
repeatedly transmitting, by the terminal, the self-registration session operation packet until the response message indicating the success of the self-registration session operation is received, when the self-registration session operation fails.

3. The method according to claim 1, wherein, the carrying the current registration information of the terminal in the self-registration session operation packet comprises: adding a node related to the current registration information of the terminal, into an extendable node of the self-registration session operation packet, and identifying the self-registration session operation packet with a message type in a predefined field.

4. The method according to claim 3, wherein, the node related to the current registration information of the terminal comprises a telephone number currently used by the terminal or a version number of the terminal.

5. The method according to claim 1, further comprising performing the following steps at a server:
receiving and parsing a self-registration session operation packet to obtain current registration information of a terminal;
judging whether the current registration information is new registration information based on pre-stored registration information of the terminal;
saving the new registration information and transmitting a response message indicating success of a self-registration session operation, when the current registration information is new registration information.

6. A terminal, comprising:
a processor; and
a memory, including instructions executable by the processor, wherein the processor is configured to:
transmit a self-registration session operation packet which carries current registration information of the terminal, when the terminal starts for a first time or registration information of the terminal is changed; and
receive a response message indicating success of a self-registration session operation, and end the self-registration session operation process.

7. The terminal according to claim 6, wherein the processor is further configured to:
repeatedly transmit the self-registration session operation packet until the response message indicating the success of the self-registration session operation is received, when the self-registration session operation fails.

8. The terminal according to claim 6, wherein, the carrying the current registration information of the terminal in the self-registration session operation packet comprises: adding a node which is related to the current registration information of the terminal, into an extendable node of the self-registration session operation packet, and identifying the self-registration session operation packet with a message type in a predefined field.

9. (canceled)

10. (canceled)

11. A non-transitory computer storage medium storing computer executable instructions for executing a method for implementing information self-registration, the method comprising:
transmitting a self-registration session operation packet which carries current registration information of a terminal, when the terminal starts for a first time or registration information of the terminal is changed;
receiving a response message indicating success of a self-registration session operation; and
ending the self-registration session operation process.

12. The non-transitory computer storage medium according to claim 11, wherein the method further comprises:
receiving and parsing a self-registration session operation packet to obtain current registration information of a terminal;
judging whether the current registration information is new registration information based on pre-stored registration information of the terminal;
saving the new registration information and transmitting a response message indicating success of a self-registration session operation, when the current registration information is new registration information.

13. The non-transitory computer storage medium according to claim 11, wherein the method further comprises:
repeatedly transmitting, by the terminal, the self-registration session operation packet until the response message indicating the success of the self-registration session operation is received, when the self-registration session operation fails.

14. The non-transitory computer storage medium according to claim 11, wherein, the carrying the current registration information of the terminal in the self-registration session operation packet comprises: adding a node related to the current registration information of the terminal, into an extendable node of the self-registration session operation packet, and identifying the self-registration session operation packet with a message type in a predefined field.

15. The non-transitory computer storage medium according to claim 13, wherein, the carrying the current registration information of the terminal in the self-registration session operation packet comprises: adding a node related to the current registration information of the terminal, into an extendable node of the self-registration session operation packet, and identifying the self-registration session operation packet with a message type in a predefined field.

16. The non-transitory computer storage medium according to claim 14, wherein, the node related to the current registration information of the terminal comprises a telephone number currently used by the terminal or a version number of the terminal.

17. The non-transitory computer storage medium according to claim 15, wherein, the node related to the current registration information of the terminal comprises a telephone number currently used by the terminal or a version number of the terminal.

18. The method according to claim 2, wherein, the carrying the current registration information of the terminal in the self-registration session operation packet comprises: adding a node related to the current registration information of the terminal, into an extendable node of the self-registration session operation packet, and identifying the self-registration session operation packet with a message type in a predefined field.

19. The method according to claim 18, wherein, the node related to the current registration information of the terminal comprises a telephone number currently used by the terminal or a version number of the terminal.

20. The terminal according to claim 7, wherein, the carrying the current registration information of the terminal in the self-registration session operation packet comprises: adding a node which is related to the current registration information of the terminal, into an extendable node of the self-registration session operation packet, and identifying the self-registration session operation packet with a message type in a predefined field.
